(19) United States
(12) Patent Application Publication
(10) Pub. No.: US 2019/0134655 A1
(43) Pub. Date: May 9, 2019

(54) EXTRUSION DEVICE AND LIQUID SUPPLY APPARATUS EMPLOYING SAME

(71) Applicant: Teco Image Systems Co., Ltd., Taipei City (TW)

(72) Inventors: Ken-Te Chou, Taipei City (TW); Yu-Jen Chang, Taipei City (TW); Cheng-Ming Liao, Taipei City (TW)

(21) Appl. No.: 15/837,580

(22) Filed: Dec. 11, 2017

(30) Foreign Application Priority Data
Nov. 6, 2017 (TW) 106138305

(51) Int. Cl. B05B 11/00

(52) U.S. Cl. CPC B05B 11/3015; B05B 11/3045; B05B 11/3074; B05B 11/3069; B05B 11/3016

(57) ABSTRACT

The present disclosure provides an extrusion device and a liquid supply apparatus employing the same. The extrusion device includes a connection base, a first elastic valve, a pump base, a second elastic valve and an outlet connector. When the movable assembly of the pump base is driven by an external force and moves toward a first hollow portion of the pump base, the first elastic valve is close, the second elastic valve is open, and the liquid inside the pump base is discharged through the pump base and the outlet connector. When the movable assembly is driven by a resilience of an elastic element and moves away from the first hollow portion, the second elastic valve is close, the first elastic valve is open, and the liquid inside a vessel flows into the pump base through the connection base and the pump base.

### CROSS-REFERENCE TO RELATED APPLICATION

This application claims priority to Taiwan Patent Application No. 106138305, filed on Nov. 6, 2017. The entire content of the above-mentioned patent application is incorporated herein by reference for all purposes.

### FIELD OF THE DISCLOSURE

The present disclosure relates to an extrusion device, and more particularly to an extrusion device, which can be assembled with a vessel and discharge the liquid inside the vessel by extrusion operation, and a liquid supply apparatus employing the same.

### BACKGROUND OF THE DISCLOSURE

As known, the extrusion device is widely applied to various vessels so as to discharge the liquid, such as the vessel containing body gel, dishwashing liquid, cosmetic, lotion or any other liquid. The corresponding extrusion device is installed to the mouth of the vessel. By the extrusion operation of the extrusion device, the liquid inside the vessel is discharged through the outlet of the extrusion device.

At present, the extrusion device includes a cap body and a pressing head. The cap body is securely mounted with the mouth of the vessel, so that the extrusion device is sealedly assembled with the vessel. The pressing head is connected with the cap body and reciprocates relative to the cap body. The pressing head includes a tube and an outlet. Therefore, the user can press the pressing head for allowing the pressing head to reciprocate, and the liquid inside the vessel is discharged through the tube and the outlet by pumping action.

However, the extrusion device is designed according to the specific vessel. Namely, the extrusion device and the corresponding vessel are regarded as a whole, and the extrusion device can't be applied to other vessel. Consequently, the application of the extrusion device is limited and the purchase cost is increased. In addition, as usual, when the liquid inside the vessel is drained off, the assembled vessel and extrusion device are abandoned together. Consequently, it causes the waste. Moreover, generally, the outlet of the extrusion device is disposed on the pressing head. When the pressing head reciprocates, the outlet is moved synchronously. Therefore, when the liquid is discharged through the outlet of the extrusion device, the position and the flow direction of the discharged liquid is uncertain. Consequently, it is inconvenient to use and disadvantageous for other application.

Therefore, there is a need of providing an extrusion device and a liquid supply apparatus employing the same in order to overcome the above drawbacks.

### SUMMARY OF THE DISCLOSURE

An object of the present disclosure is to provide an extrusion device and a liquid supply apparatus employing the same. The extrusion device can be detachably assembled with the vessel containing liquid. The vessel is replaceable, and thus the applicability of the extrusion device is enhanced. In addition, the extrusion device can be securely mounted in the housing of the liquid supply apparatus. Therefore, the extrusion device is pushed by the pushing device inside the liquid supply apparatus, and the liquid supply apparatus can realize the function of automatic liquid supply.

Another object of the present disclosure is to provide an extrusion device and a liquid supply apparatus employing the same. The extrusion device draws the liquid from the vessel by the reciprocation of the movable assembly, and discharges the drawn liquid through the opening of the outlet connector. During the moving process of the movable assembly, the position of the opening is fixed, thus the position and the flow direction of the discharged liquid is fixed. Consequently, the inventive extrusion device is convenient to use and capable of being applied in the liquid supply apparatus.

In accordance with an aspect of the present disclosure, there is provided an extrusion device. The extrusion device includes a connection base, a first elastic valve, a pump base, a second elastic valve and an outlet connector. The connection base includes a first end part, a second end part and a liquid supply needle. The first end part is opposite to the second end part and is configured to be detachably assembled with a vessel. The liquid supply needle is disposed in the first end part and includes a hollow needle portion. The hollow needle portion is configured to penetrate through a vessel opening of the vessel so as to be in communication with a first liquid receiving space of the vessel. The first elastic valve is disposed in the second end part of the connection base and is aligned with the hollow needle portion. The pump base is assembled with the connection base and includes a first tube, a movable assembly and an elastic element. The first tube includes a first hollow portion, a second liquid receiving space, a third end part, a fourth end part and a fifth end part. The fifth end part is assembled with the second end part and is closely connected with the first elastic valve. The first hollow portion is in communication with the second liquid receiving space. The first hollow portion is aligned with the first elastic valve. The movable assembly is partially accommodated in the second liquid receiving space of the first tube. The movable assembly can move relative to the first tube in accordance with an external force. The elastic element is sleeved on the movable assembly. The second elastic valve is disposed in the third end part and is aligned with the first hollow portion. The outlet connector is assembled with the third end part and includes a second tube. The second tube includes a second hollow portion and an opening. A terminal of the second tube is assembled with the third end part and is closely connected with the second elastic valve. The opening is disposed on the other terminal of the second tube. The opening is in communication with the second hollow portion. The second hollow portion is aligned with the second elastic valve. When the movable assembly is driven by the external force and moves toward the first hollow portion, the first elastic valve is close, the second elastic valve is open, and the liquid inside the second liquid receiving space is discharged through the first hollow portion, the second hollow portion and the opening. When the movable assembly is driven by a resilience of the elastic element and moves away from the first hollow portion, the second elastic valve is close, the first elastic valve is open, and the liquid inside the first liquid receiving space flows into the second liquid receiving space through the hollow needle portion and the first hollow portion.

In accordance with another aspect of the present disclosure, there is provided a liquid supply apparatus. The liquid supply apparatus includes a housing, at least one extrusion device, a pushing device and a driving device. The extrusion device is disposed in the housing and is assembled with the housing. Each extrusion device includes a connection base, a first elastic valve, a pump base, a second elastic valve and an outlet connector. The connection base includes a first end part, a second end part and a liquid supply needle. The first end part is opposite to the second end part and is configured to be detachably assembled with a vessel. The liquid supply needle is disposed in the first end part and includes a hollow needle portion. The hollow needle portion is configured to penetrate through a vessel opening of the vessel so as to be in communication with a first liquid receiving space of the vessel. The first elastic valve is disposed in the second end part of the connection base and is aligned with the hollow needle portion. The pump base is assembled with the connection base and includes a first tube, a movable assembly and an elastic element. The first tube includes a first hollow portion, a second liquid receiving space, a third end part, a fourth end part and a fifth end part. The fifth end part is assembled with the second end part and is closely connected with the first elastic valve. The first hollow portion is in communication with the second liquid receiving space. The first hollow portion is aligned with the first elastic valve. The movable assembly is partially accommodated in the second liquid receiving space of the first tube. The movable assembly can move relative to the first tube in accordance with an external force. The elastic element is sleeved on the movable assembly. The second elastic valve is disposed in the third end part and is aligned with the first hollow portion. The outlet connector is assembled with the third end part and includes a second tube. The second tube includes a second hollow portion and an opening. A terminal of the second tube is assembled with the third end part and is closely connected with the second elastic valve. The opening is disposed on the other terminal of the second tube. The opening is in communication with the second hollow portion. The second hollow portion is aligned with the second elastic valve. When the movable assembly is driven by the external force and moves toward the first hollow portion, the first elastic valve is close, the second elastic valve is open, and the liquid inside the second liquid receiving space is discharged through the first hollow portion, the second hollow portion and the opening. When the movable assembly is driven by a resilience of the elastic element and moves away from the first hollow portion, the second elastic valve is close, the first elastic valve is open, and the liquid inside the first liquid receiving space flows into the second liquid receiving space through the hollow needle portion and the first hollow portion. The pushing device is disposed in the housing and corresponding to the movable assembly of the extrusion device. The pushing device is configured to push against the movable assembly. The driving device is connected with the pushing device. The driving device is configured to driving the pushing device.

### BRIEF DESCRIPTION OF THE DRAWINGS

FIG. 1 is a schematic perspective view illustrating an extrusion device assembled with a vessel according to an embodiment of the present disclosure;

FIG. 2 is an exploded view illustrating the extrusion device and the vessel of FIG. 1;

FIG. 3 is a cross-section view taken along the plane AA of FIG. 1;

FIG. 4 is a cross-section view taken along the plane AA of FIG. 1, wherein the movable assembly is moved toward the first hollow portion; and

FIG. 5 is a cross-section view of a liquid supply apparatus according to an embodiment of the present disclosure.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

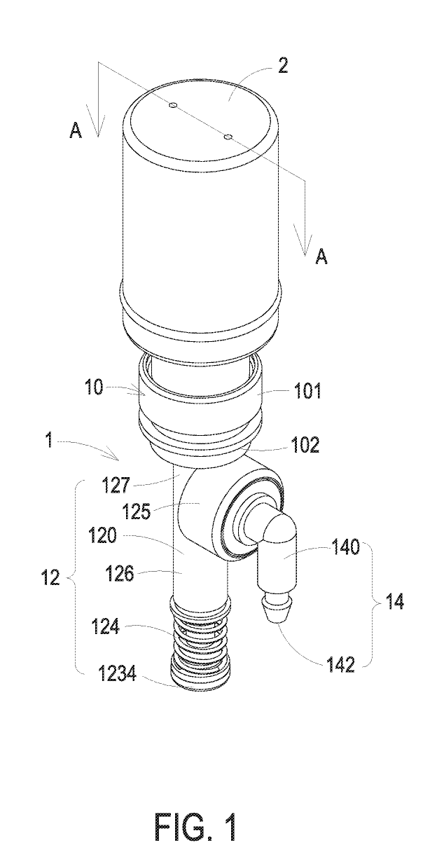

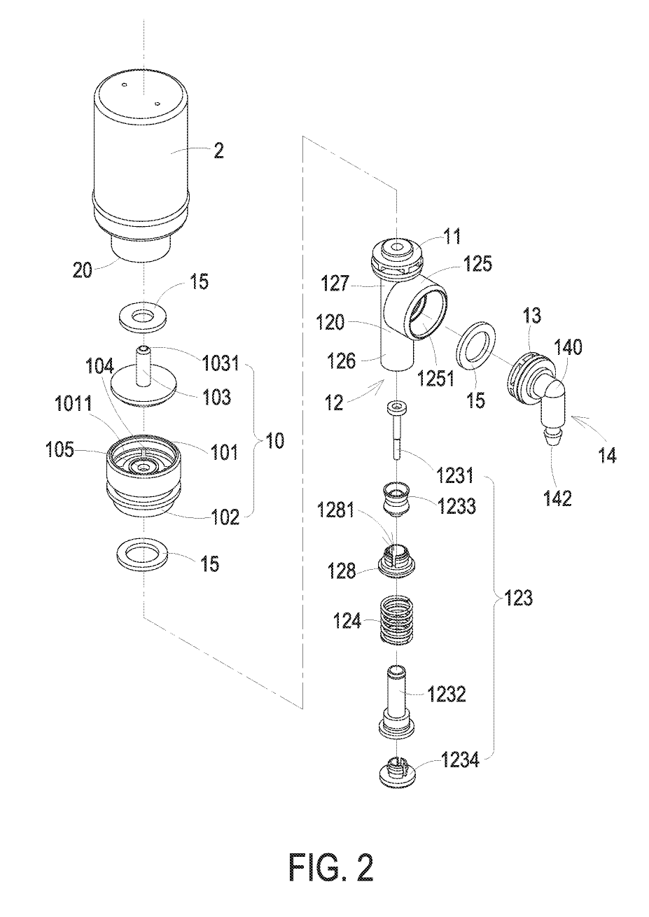

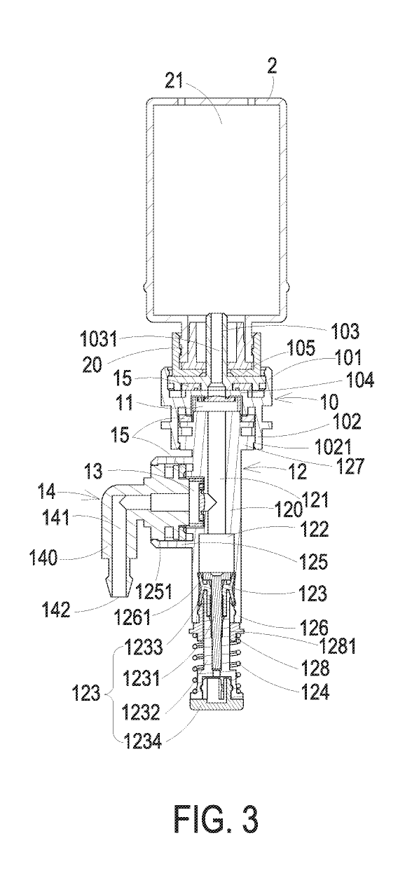

FIG. 1 is a schematic perspective view illustrating an extrusion device assembled with a vessel according to an embodiment of the present disclosure. FIG. 2 is an exploded view illustrating the extrusion device and the vessel of FIG. 1. FIG. 3 is a cross-section view taken along the plane AA of FIG. 1. As shown in FIGS. 1, 2 and 3, the extrusion device 1 includes a connection base 10, a first elastic valve 11, a pump base 12, a second elastic valve 13 and an outlet connector 14.

The connection base 10 includes a first end part 101, a second end part 102 and a liquid supply needle 103. The first end part 101 and the second end part 102 are separated from each other by a separator plate 104. The separator plate 104 possesses a through hole 105. The liquid supply needle 103 is disposed in the first end part 101 and includes a hollow needle portion 1031. The first end part 101 is configured to be detachably assembled with the vessel 2. The vessel 2 can be a bottle containing liquid. The vessel 2 includes a vessel opening 20 and a first liquid receiving space 21. When the vessel opening 20 of the vessel 2 is assembled with the first end part 101 of the connection base 10, the liquid supply needle 103 at least partially penetrates into the vessel 2 through the vessel opening 20. Therefore, the hollow needle portion 1031 is in communication with the first liquid receiving space 21.

In an embodiment, the first end part 101 includes a first accommodation space 1011. The liquid supply needle 103 is at least partially located in the first accommodation space 1011. When the vessel opening 20 of the vessel 2 is assembled with the first end part 101 of the connection base 10, the vessel opening 20 is at least partially located in the first accommodation space 1011. The second end part 102 of the connection base 10 includes a second accommodation space 1021. The first accommodation space 1011 of the first end part 101 is in communication with the second accommodation space 1021 of the second end part 102 through the through hole 105 of the separator plate 104. When the liquid supply needle 103 is disposed in the first accommodation 1011 of the first end part 101, the hollow needle portion 1031 is aligned with the through hole 105. Therefore, the hollow needle portion 1031 is in communication with the second accommodation space 1021.

The first elastic valve 11 is disposed in the second end part 102 of the connection base 10 and located in the second accommodation space 1021. Moreover, the first elastic valve 11 is aligned with the hollow needle portion 1031 of the liquid supply needle 103 and the through hole 105. The first elastic valve 11 is configured to be a check valve for selectively closing or opening the flow channel of the through hole 105 and the hollow needle portion 1031. Accordingly, the fluid inside the vessel 2 is stopped or allowed to flow away from the vessel 2. Moreover, the first elastic valve 11 prevents the fluid from reverse flowing.

The pump base 12 is assembled with the second end part 102 of the connection base 10 and includes a first tube 120, a movable assembly 123 and an elastic element 124. The first tube 120 is a three-way tube and includes a first hollow portion 121, a second liquid receiving space 122, a third end part 125, a fourth end part 126 and a fifth end part 127, which are in communication with each other. The first hollow portion 121 is located between the first elastic valve 11 and the second liquid receiving space 122. The aperture of the second liquid receiving space 122 is larger than the aperture of the first hollow portion 121. The fifth end part 127 of the first tube 120 is assembled with the second end part 102 of the connection base 10, and the fifth end part 127 is closely connected with the first elastic valve 11. Moreover, the first hollow portion 121 is aligned with the first elastic valve 11. When the first elastic valve 11 is open, the first hollow portion 121 is in communication with the through hole 105 and the hollow needle portion 1031. The fourth end part 126 is opposite to the fifth end part 127. The second liquid receiving space 122 is disposed in the fourth end part 126. Part of the second liquid receiving space 122 is configured to accommodate the movable assembly 123, and the movable assembly 123 is disposed corresponding to the second liquid receiving space 122. The movable assembly 123 can be moved toward the first hollow portion 121, so as to reduce the room of the second liquid receiving space 122 and extrude the liquid therein. Whereas, the movable assembly 123 can also be moved away from the first hollow portion 121, so as to increase the room of the second liquid receiving space 122 and the liquid therein. The elastic element 124 is sleeved on the movable assembly 123. Preferably but not exclusively, the elastic element 124 is a spring. In an embodiment, the fifth end part 127 of the pump base 12 is at least partially located in the second accommodation space 1021 of the second end part 102 of the connection base 10.

In an embodiment, the connection base 10 further includes a pump cover 128. The pump cover 128 is securely mounted with the fourth end part 126 of the first tube 120, and is partially located in the fourth accommodation space 1261 of the fourth end part 126. The pump cover 128 includes a hole 1281. Therefore, the movable assembly 123 can partially penetrate the pump cover 128 through the hole 1281 and reciprocates relative to the pump cover 128. Preferably but not exclusively, the pump cover 128 is assembled with the fourth end part 126 of the first tube 120 by engagement.

The second elastic valve 13 is disposed in the third end part 125 of the pump base 12 and aligned with the first hollow portion 121. The second elastic valve 13 is configured to be a check valve for selectively closing or opening the flow channel of the first hollow portion 121. Accordingly, the fluid inside the second liquid receiving space 122 is stopped or allowed to be away from the second liquid receiving space 122 and flow toward the outlet connector 14. Moreover, the second elastic valve 13 prevents the fluid from reverse flowing. In an embodiment, the third end part 125 is located between the fifth end part 127 and the fourth end part 126, and protrudes outwardly from the sidewall of the first tube 120.

The outlet connector 14 is assembled with the third end part 125 of the pump base 12 and includes a second tube 140. The second tube 140 includes a second hollow portion 141 and an opening 142. The second hollow portion 141 is disposed in the second tube 140. One terminal of the second tube 140 is assembled with the third end part 125 of the first tube 120, and is closely connected with the second elastic valve 13. The opening 142 is disposed on the other terminal of the second tube 140. The opening 142 is in communication with the second hollow portion 141. The second hollow portion 141 is aligned with the second elastic valve 13. Therefore, when the second elastic valve 13 is open, the second hollow portion 141 is in communication with the first hollow portion 121. In an embodiment, the third end part 125 of the first tube 120 includes a third accommodation space 1251. The second elastic valve 13 is located in the third accommodation space 1251. The outlet connector 14 is at least partially located in the third accommodation space 1251. In an embodiment, the second tube 140 is an L-type tube but not limited thereto.

In an embodiment, preferably, the fifth end part 127 of the first tube 120 is assembled with the second end part 102 of the connection base 10 by engagement, and the second tube 140 of the outlet connector 14 is assembled with the third end part 125 of the first tube 120 by engagement. Nevertheless, the mean of assembling the fifth end part 127 with the second end part 102 and assembling the second tube 140 with the third end part 125 is not limited to the said engagement. Other assembly means, such as screwing, locking, sticking and so on, can be employed as well.

In an embodiment, the movable assembly 123 includes a first push rod 1231, a second push rod 1232, a rubber element 1233 and a bottom cover 1234. The rubber element 1233 is for example but not limited to a leather cup. The rubber element 1233 is sleeved on the second push rod 1232. The first push rod 1231 at least partially penetrates the rubber element 1233, and is partially inserted into the second push rod 1232. The first push rod 1231 and the second push rod 1232 are securely connected with each other and move synchronously. The bottom cover 1234 is connected with an end part of the second push rod 1232. The elastic element 124 is sleeved on the second push rod 1232. The elastic element 124 can be located between the pump cover 128 and the bottom cover 1234, or between the pump cover 128 and the said end part of the second push rod 1232, but is not limited thereto. In an embodiment, the rubber element 1233 is located in the fourth accommodation space 1261. The first push rod 1231 and the second push rod 1232 at least partially penetrate through the hole 1281 of the pump cover 128 and be located in the fourth accommodation space 1261.

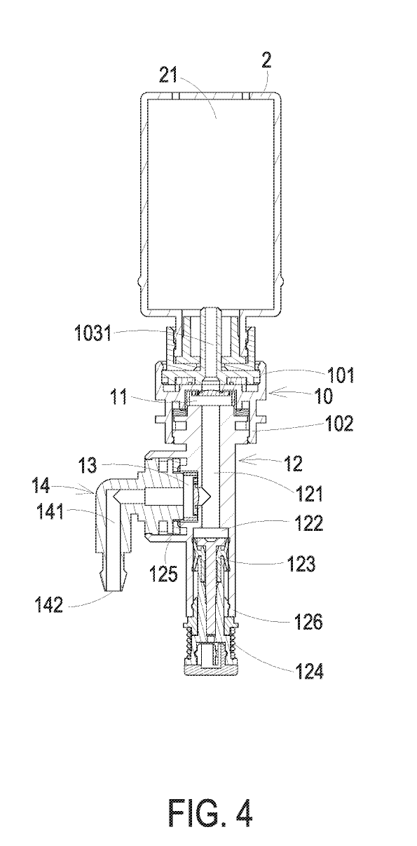

In an embodiment, by the reciprocation of the movable assembly 123, the extrusion device 1 draws the liquid from the first liquid receiving space 21 of the vessel 2, and discharges the drawn liquid through the opening 142 of the outlet connector 14. The action principle thereof is described in detail as follows. FIG. 4 is a cross-section view taken along the plane AA of FIG. 1, wherein the movable assembly is moved toward the first hollow portion. As shown in FIG. 4, when the movable assembly 123 is driven by an external force and moves toward the first hollow portion 121, the elastic element 124 is compressed in accordance with the movement of the movable assembly 123, and the first elastic valve 11 is close. Namely, the disc of the first elastic valve 11 divides the through hole 105 from the first hollow portion 121, and prevents the liquid from reversely flowing into the first liquid receiving space 21 of the vessel 2. Meanwhile, the room of the second liquid receiving space 122 is decreased due to the extrusion from the movable assembly 123. The fluid inside the first hollow portion 121 and the second liquid receiving space 122 is extruded and thus pushes the disc of the second elastic valve 13 to move toward the second hollow portion 141. Therefore, the second elastic valve 13 is open, and the first hollow portion 121 is in communication with the second hollow portion 141. Consequently, during the process of the movable assembly 123 moving toward the first hollow portion 121, the liquid inside the second liquid receiving space 122 can be discharged through first hollow portion 121, the second hollow portion 141 and the opening 142.

Afterward, when the external force exerted on the movable assembly 123 is released, the resilience of the elastic element 124 drives the movable assembly 123 to move away from the first hollow portion 121, and the second elastic valve 13 is close. Namely, the disc of the second elastic valve 13 divides the first hollow portion 121 from the second hollow portion 141. Meanwhile, the room of the second liquid receiving space 122 is increased due to the movable assembly 123 moving away from the first hollow portion 121. Accordingly, the differential pressure causes the vacuum suction. The vacuum suction drives the disc of the first elastic valve 11 to move toward the first hollow portion 121. Therefore, the first elastic valve 11 is open, and the hollow needle portion 1031 and the through hole 105 are in communication with the first hollow portion 121. Consequently, during the process of the movable assembly 123 moving away from the first hollow portion 121, the liquid inside the first liquid receiving space 21 of the vessel 2 flows into the second liquid receiving space 122 through the hollow needle portion 1031 and the first hollow portion 121. As the resilience of the elastic element 124 gradually becomes to zero, the movable assembly 123 gradually stops moving. When the movable assembly 12 becomes static, the position of the structures of the extrusion device 1 restores to the original position and status of the extrusion device 1 shown in FIGS. 1, 2 and 3. From the above, it is known that the inventive extrusion device 1 can draw the liquid from the first liquid receiving space 21 of the vessel 2 and discharge the drawn liquid through the opening 142 of the outlet connector 14. Meanwhile, the position of the opening 142 is fixed.

For preventing the liquid from leaking, in an embodiment, the extrusion device further includes plural sealing rings 15, such as three sealing rings 15. One sealing ring 15 is disposed in the first accommodation space 1011 of the first end part 101, and is located between the vessel opening 20 of the vessel 2 and the liquid supply needle 103. Another sealing ring 15 is disposed in the second accommodation space 1021 of the second end part 102, and is located between the separator plate 104 of the connection base 10 and the first elastic valve 11. The other sealing ring 15 is disposed in the third accommodation space 1251 of the third end part 125, and is located between the second elastic valve 13 and the second hollow portion 121. It is emphasized that the amount and the disposition position of the sealing ring 15 can be varied according to the actual requirement, but are not limited to that of the above-mentioned embodiments.

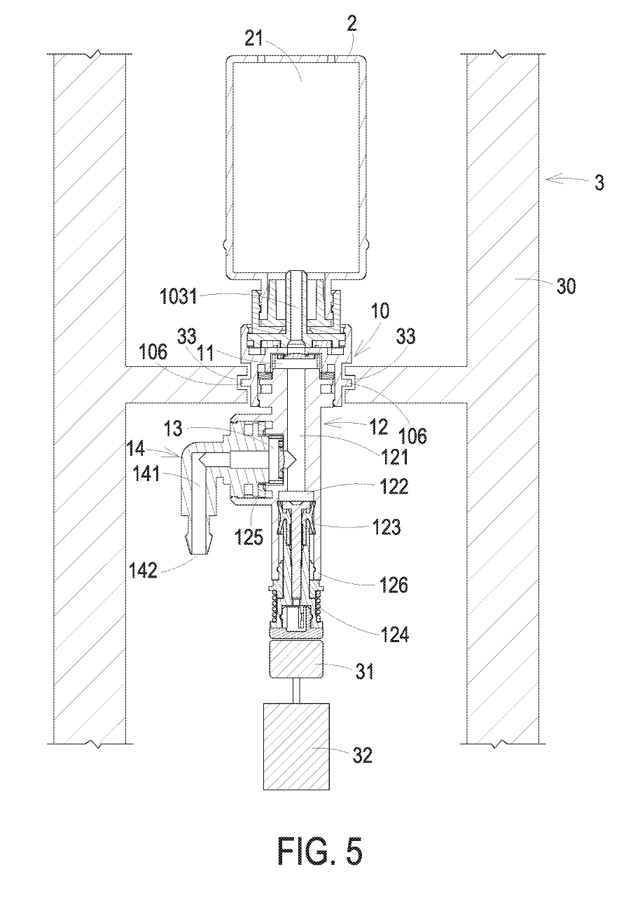

FIG. 5 is a cross-section view of a liquid supply apparatus according to an embodiment of the present disclosure. As shown in FIG. 5, the liquid supply apparatus 3 includes at least one extrusion device 1, a housing 30, a pushing device 31 and a driving device 32. The structure of the extrusion device 1 and the assembled vessel 2 is the same as that of FIGS. 1, 2 and 3, and is not redundantly described herein. In this embodiment, the connection base 10 of the extrusion device 1 includes at least one first engaging element 106. The first engaging element 106 is disposed on the outside of the second end part 102. The housing 30 includes at least one second engaging element 33, which is disposed corresponding to the first engaging element 106. By the engagement between the first engaging element 106 and the second engaging element 33, the extrusion device 1 is assembled in the housing 30. The pushing device 31 is disposed in the housing 30. Moreover, the pushing device 31 is disposed corresponding to the movable assembly 123 of the extrusion device 1, and is applied for pushing against the movable assembly 123. The driving device 32 is disposed in the housing 30 and is connected with the pushing device 31. The driving device 32 is applied for pushing against the pushing device 31. Consequently, by the pushing device 31 of the liquid supply apparatus 3 pushing against the movable assembly 123 of the extrusion device 1, the liquid supply apparatus 3 can realize the function of automatic liquid supply.

In summary, the present disclosure provides an extrusion device and a liquid supply apparatus employing the same. The extrusion device can be detachably assembled with the vessel containing liquid. The vessel is replaceable, and thus the applicability of the extrusion device is enhanced. In addition, the extrusion device can be securely mounted in the housing of the liquid supply apparatus. Therefore, the extrusion device is pushed by the pushing device inside the liquid supply apparatus, and the liquid supply apparatus can realize the function of automatic liquid supply. Moreover, the extrusion device draws the liquid from the vessel by the reciprocation of the movable assembly, and discharges the drawn liquid through the opening of the outlet connector. During the moving process of the movable assembly, the position of the opening is fixed, thus the position and the flow direction of the discharged liquid is fixed. Consequently, the inventive extrusion device is convenient to use and capable of being applied in the liquid supply apparatus.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An extrusion device comprising:
a connection base comprising a first end part, a second end part and a liquid supply needle, wherein the first end part is opposite to the second end part and is configured to be detachably assembled with a vessel, the liquid supply needle is disposed in the first end part and includes a hollow needle portion, and the hollow needle portion is configured to penetrate through a vessel opening of the vessel so as to be in communication with a first liquid receiving space of the vessel;
a first elastic valve disposed in the second end part of the connection base and aligned with the hollow needle portion;
a pump base assembled with the connection base, and comprising:
a first tube comprising a first hollow portion, a second liquid receiving space, a third end part, a fourth end part and a fifth end part, wherein the fifth end part is assembled with the second end part and is closely connected with the first elastic valve, the first hollow portion is in communication with the second liquid receiving space, and the first hollow portion is aligned with the first elastic valve;
a movable assembly partially accommodated in the second liquid receiving space of the first tube, wherein the movable assembly can move relative to the first tube in accordance with an external force; and
an elastic element sleeved on the movable assembly;
a second elastic valve disposed in the third end part and aligned with the first hollow portion; and
an outlet connector assembled with the third end part and comprising a second tube, wherein the second tube comprises a second hollow portion and an opening, a terminal of the second tube is assembled with the third end part and is closely connected with the second elastic valve, the opening is disposed on the other terminal of the second tube, the opening is in communication with the second hollow portion, and the second hollow portion is aligned with the second elastic valve;
wherein when the movable assembly is driven by the external force and moves toward the first hollow portion, the first elastic valve is close, the second elastic valve is open, and the liquid inside the second liquid receiving space is discharged through the first hollow portion, the second hollow portion and the opening, wherein when the movable assembly is driven by a resilience of the elastic element and moves away from the first hollow portion, the second elastic valve is close, the first elastic valve is open, and the liquid inside the first liquid receiving space flows into the second liquid receiving space through the hollow needle portion and the first hollow portion.

2. The extrusion device according to claim 1, wherein the connection base further comprises a separator plate, the separator plate is configured to separate the first end part from the second end part, the separator plate comprises a through hole, the hollow needle portion and the first elastic valve is aligned with the through hole respectively, and when the first elastic valve is open, the first hollow portion is in communication with the through hole and the hollow needle portion.

3. The extrusion device according to claim 1, wherein the first end part of the connection base comprises a first accommodation space, the liquid supply needle is at least partially located in the first accommodation space, and when the vessel is assembled with the first end part, the vessel is at least partially located in the first accommodation space.

4. The extrusion device according to claim 1, wherein the second end part of the connection base comprises a second accommodation space, the first elastic valve is located in the second accommodation, and the fifth end part of the pump base is at least partially located in the second accommodation space.

5. The extrusion device according to claim 1, wherein the third end part of the pump base comprises a third accommodation space, the second elastic valve is located in the third accommodation space, and the outlet connector is at least partially located in the third accommodation space.

6. The extrusion device according to claim 1, further comprising plural sealing rings, wherein the plural sealing rings are disposed in the first end part, the second end part and third end part respectively.

7. The extrusion device according to claim 1, wherein the fourth end part of the pump base comprises a fourth accommodation space, and the movable assembly is at least partially located in the fourth accommodation space.

8. The extrusion device according to claim 7, wherein the pump base further comprises a pump cover, the pump cover is securely mounted on the fourth end part and comprises a hole, and the movable assembly is partially disposed in the fourth accommodation space through the hole.

9. The extrusion device according to claim 7, wherein the movable assembly comprises a first push rod, a second push rod and a bottom cover, the first push rod is partially inserted into the second push rod, the elastic element is sleeved on the second push rod, the bottom cover is connected with a terminal of the second push rod, and the first push rod and the second push rod are at least partially located in the fourth accommodation space.

10. The extrusion device according to claim 9, wherein the movable assembly further comprises a rubber element, the rubber element is sleeved on the second push rod and is located in fourth accommodation space, and the first push rod partially penetrates through the rubber element so as to be inserted into the second push rod.

11. The extrusion device according to claim 10, wherein the rubber element is a leather cup.

12. A liquid supply apparatus comprising:
a housing;
at least one extrusion device, wherein the extrusion device is disposed in the housing and is assembled with the housing, and each extrusion device comprises:
a connection base comprising a first end part, a second end part and a liquid supply needle, wherein the first end part is opposite to the second end part and is configured to be detachably assembled with a vessel, the liquid supply needle is disposed in the first end part and includes a hollow needle portion, and the hollow needle portion is configured to penetrate through a vessel opening of the vessel so as to be in communication with a first liquid receiving space of the vessel;
a first elastic valve disposed in the second end part of the connection base and aligned with the hollow needle portion;
a pump base assembled with the connection base, and comprising:
a first tube comprising a first hollow portion, a second liquid receiving space, a third end part, a fourth end part and a fifth end part, wherein the fifth end part is assembled with the second end part and is closely connected with the first elastic valve, the first hollow portion is in communication with the second liquid receiving space, and the first hollow portion is aligned with the first elastic valve;
a movable assembly partially accommodated in the second liquid receiving space of the first tube, wherein the movable assembly can move relative to the first tube in accordance with an external force; and
an elastic element sleeved on the movable assembly;
a second elastic valve disposed in the third end part and aligned with the first hollow portion; and
an outlet connector assembled with the third end part and comprising a second tube, wherein the second tube comprises a second hollow portion and an opening, a terminal of the second tube is assembled with the third end part and is closely connected with the second elastic valve, the opening is disposed on the other terminal of the second tube, the opening is in communication with the second hollow portion, and the second hollow portion is aligned with the second elastic valve;
wherein when the movable assembly is driven by the external force and moves toward the first hollow portion, the first elastic valve is close, the second elastic valve is open, and the liquid inside the second liquid receiving space is discharged through the first hollow portion, the second hollow portion and the opening, wherein when the movable assembly is driven by a resilience of the elastic element and moves away from the first hollow portion, the second elastic valve is close, the first elastic valve is open, and the liquid inside the first liquid receiving space flows into the second liquid receiving space through the hollow needle portion and the first hollow portion;
a pushing device disposed in the housing and corresponding to the movable assembly of the extrusion device, wherein the pushing device is configured to push against the movable assembly; and
a driving device connected with the pushing device, wherein the driving device is configured to driving the pushing device.

13. The liquid supply apparatus according to claim 12, wherein the extrusion device further comprises at least one first engaging element, the housing comprises at least one second engaging element, the second engaging element is disposed corresponding to the first engaging element, and the first engaging element is engaged with the second engaging element so that the extrusion device is assembled with the housing.

14. The liquid supply apparatus according to claim 12, wherein the connection base further comprises a separator plate, the separator plate is configured to separate the first end part from the second end part, the separator plate comprises a through hole, the hollow needle portion and the first elastic valve is aligned with the through hole respectively, and when the first elastic valve is open, the first hollow portion is in communication with the through hole and the hollow needle portion.

15. The liquid supply apparatus according to claim 12, wherein the first end part of the connection base comprises a first accommodation space, the liquid supply needle is at least partially located in the first accommodation space, and when the vessel is assembled with the first end part, the vessel is at least partially located in the first accommodation space.

16. The liquid supply apparatus according to claim 12, wherein the second end part of the connection base comprises a second accommodation space, the first elastic valve is located in the second accommodation, and the fifth end part of the pump base is at least partially located in the second accommodation space.

17. The liquid supply apparatus according to claim 12, wherein the third end part of the pump base comprises a third accommodation space, the second elastic valve is located in the third accommodation space, and the outlet connector is at least partially located in the third accommodation space.

18. The liquid supply apparatus according to claim 12, further comprising plural sealing rings, wherein the plural sealing rings are disposed in the first end part, the second end part and third end part respectively.

19. The liquid supply apparatus according to claim 12, wherein the fourth end part of the pump base comprises a fourth accommodation space, and the movable assembly is at least partially located in the fourth accommodation space.

20. The liquid supply apparatus according to claim 19, wherein the movable assembly comprises a first push rod, a second push rod and a bottom cover, the first push rod is partially inserted into the second push rod, the elastic element is sleeved on the second push rod, the bottom cover is connected with a terminal of the second push rod, and the first push rod and the second push rod are at least partially located in the fourth accommodation space.
